(19) United States
(12) Patent Application Publication
(10) Pub. No.: US 2025/0094727 A1
(43) Pub. Date: Mar. 20, 2025

(54) SYSTEM AND METHOD FOR DETERMINING TOPICS BASED ON SELECTIVE TOPIC MODELS

(71) Applicant: Walmart Apollo, LLC, Bentonville, AR (US)

(72) Inventors: Tolgahan Cakaloglu, Melissa, TX (US); Karthik Ravichandran, Tiruchirappalli (IN)

(21) Appl. No.: 18/466,940

(22) Filed: Sep. 14, 2023

(51) Int. Cl. G06F 40/40; G06F 16/35; G06F 40/205

(52) U.S. Cl. CPC G06F 40/40; G06F 16/355; G06F 40/205

(57) ABSTRACT

Systems and methods for determining topics for a document based on selective topic models are disclosed. In some embodiments, a disclosed method includes: obtaining at least one document; applying a plurality of topic models to the at least one document to identify at least one topic associated with the at least one document; selecting a topic model from the plurality of topic models based on the at least one topic; generating topic related data comprising data associated with a topic identified based on the selected topic model; and storing the topic related data in a database.

### TECHNICAL FIELD

This application relates generally to topic modelling and, more particularly, to systems and methods for determining topics for a document based on selective topic models.

### BACKGROUND

Given a set of text documents, such as customer comments, associate comments or product descriptions, a model is desired to extract granular insights so that business decision-makers can take actions accordingly. For example, a topic model can be used to determine topics of documents for any type of text mining or unsupervised text analysis. Topic modelling may be used extensively, from customer feedback text to product description analysis and open-door survey. In addition, topic modelling can provide a starting point of converting any unlabeled text data at an unsupervised setting to intelligently labelled data viewed as supervised data.

Some existing systems stick with a fixed and single topic model to determine document topics, which may lose some qualified topic to cause a wrong decision or huge cost. While there are many open source embedding approaches with numerous topic modelling algorithms, each algorithm has its own way of datapoint projection and some algorithm will generate more or less topics than others. Using only one algorithm will make insights generated by other algorithm totally ignored. Based on current technology, combining different topic modelling algorithms is not only time and resource consuming but also demanding human effort to tune and find the best combination, where it is not an easy task to identify a best model for topic modelling with proper embeddings.

### SUMMARY

The embodiments described herein are directed to systems and methods for determining topics for a document based on selective topic models.

In various embodiments, a system including a non-transitory memory configured to store instructions thereon and at least one processor is disclosed. The at least one processor is configured to read the instructions to: obtain at least one document; apply a plurality of topic models to the at least one document to identify at least one topic associated with the at least one document; select a topic model from the plurality of topic models based on the at least one topic; generate topic related data comprising data associated with a topic identified based on the selected topic model; and store the topic related data in a database.

In various embodiments, a computer-implemented method is disclosed. The computer-implemented method includes: obtaining at least one document; applying a plurality of topic models to the at least one document to identify at least one topic associated with the at least one document; selecting a topic model from the plurality of topic models based on the at least one topic; generating topic related data comprising data associated with a topic identified based on the selected topic model; and storing the topic related data in a database.

In various embodiments, a non-transitory computer readable medium having instructions stored thereon is disclosed. The instructions, when executed by at least one processor, cause at least one device to perform operations including: obtaining at least one document; applying a plurality of topic models to the at least one document to identify at least one topic associated with the at least one document; selecting a topic model from the plurality of topic models based on the at least one topic; generating topic related data comprising data associated with a topic identified based on the selected topic model; and storing the topic related data in a database.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured to determine topics based on selective topic models, in accordance with some embodiments of the present teaching.

FIG. 2 is a block diagram of a topic computing device, in accordance with some embodiments of the present teaching.

FIG. 3 illustrates a block diagram showing various portions of a topic computing device in a training stage, in accordance with some embodiments of the present teaching.

FIG. 4 illustrates a block diagram showing various portions of a topic computing device in an inference stage, in accordance with some embodiments of the present teaching.

FIG. 5 illustrates a block diagram of a primary and secondary topic selector operating in a first phase, in accordance with some embodiments of the present teaching.

FIG. 6 illustrates a block diagram of a primary and secondary topic selector operating in a second phase, in accordance with some embodiments of the present teaching.

FIG. 7 illustrates a block diagram of a primary and secondary topic selector operating in a third phase, in accordance with some embodiments of the present teaching.

FIG. 8 is a flowchart illustrating an exemplary method for determining topics based on selective topic models, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

A topic model can determine topics of a corpus of documents to generate labels and annotate the documents. When multiple topic models are used together, a selection mechanism is desired to select a primary model out of them, following an easy and manageable selection process.

One goal of the present teaching is to fuse topics determined from different topic models to capture all topics of a document and remove redundant topics at the same time. This can eliminate the risk of single model dependency and potential topic loss. In some embodiments, a disclosed system combines multiple topic modelling algorithms or topic models with sample sentences and description generation, with a topic selection strategy utilized to fuse the topic models.

The multiple topic models may be combined to generate holistic sets of topics for a given corpus of documents. These multiple topic models may include both embedding based topic models and document-term matrix (DTM) based topic models. In some embodiments, multiple sentence embedding models can be fused together using a multi-resolution embedding approach to generate embeddings of the document corpus for the embedding based topic models. Once the framework of the system is set up, any new topic model or new sentence embedding model can be added to the system directly without impacting the operation flow of the system. In some embodiments, sample sentences are extracted for each identified topic of the document corpus. In addition, n-chunk, summarization and question-answering techniques can be used to generate labelling, name and descriptions for each topic.

In some embodiments, the system includes a primary and secondary topic selector to automatically select a primary topic model from a given set of topic models. The primary topic model may be selected by ranking the topic models based on their respective similarity scores. A higher similarity score for a topic model may indicate a higher probability or degree that topics identified by the topic model are overlapping with topics identified by other topic models.

While the primary topic model may identify primary topics for a given dataset, the system may also use a secondary selection mechanism to select secondary topics identified by secondary topic models, which are the remaining topic models other than the primary topic model. The selected secondary topics are non-overlapping with the primary topics, and selected based on one or more cluster comparison methods.

In some embodiments, the primary topics and selected secondary topics are stored into a database, together with sample sentences, name and description associated with each of these topics. When a new document is obtained for topic inference, sentence embeddings can be generated for the new document and the sample sentences pre-associated with topics. Then, a universal classifier can be used to predict or infer topics of the new document based on these sentence embeddings, e.g. based on few-shot learning.

Furthermore, in the following, various embodiments are described with respect to methods and systems for determining topics for a document based on selective topic models are disclosed. In some embodiments, a disclosed method includes: obtaining at least one document; applying a plurality of topic models to the at least one document to identify at least one topic associated with the at least one document; selecting a topic model from the plurality of topic models based on the at least one topic; generating topic related data comprising data associated with a topic identified based on the selected topic model; and storing the topic related data in a database.

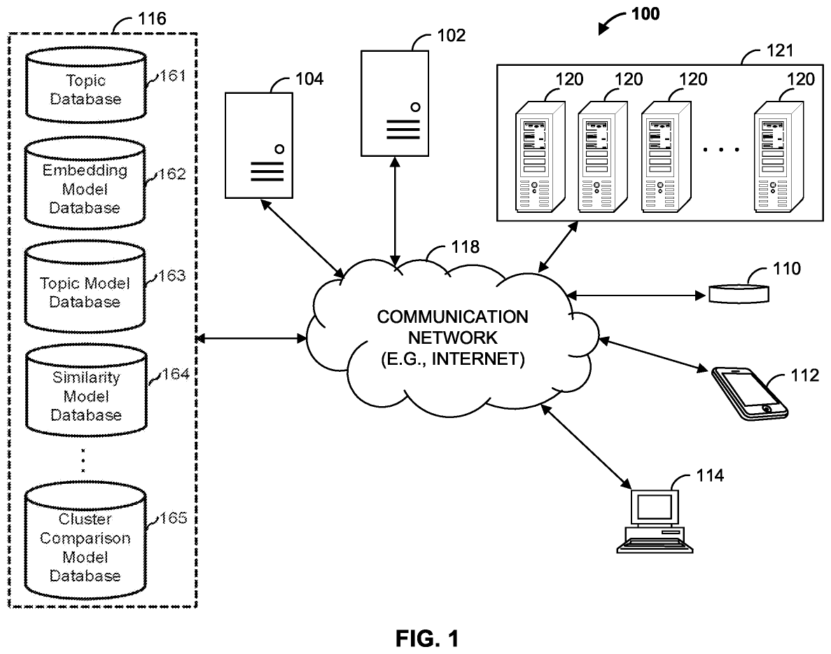

Turning to the drawings, FIG. 1 is a network environment 100 configured to determine topics based on selective topic models, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, a topic computing device 102 (e.g., a server, such as an application server), a web server 104, a cloud-based engine 121 including one or more processing devices 120, databases 116, and one or more user computing devices 110, 112, 114 operatively coupled over the network 118. The topic computing device 102, the web server 104, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the topic computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the topic computing device 102.

In some examples, each of the multiple user computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more websites, e.g. retailer websites providing one or more products or services. In some examples, the topic computing device 102, the processing devices 120, and/or the web server 104 are operated by a same business or entity. The multiple user computing devices 110, 112, 114 may be operated by users associated with the websites. In some examples, the processing devices 120 are operated by a third party (e.g., a cloud-computing provider).

Although FIG. 1 illustrates three user computing devices 110, 112, 114, the network environment 100 can include any number of user computing devices 110, 112, 114. Similarly, the network environment 100 can include any number of the topic computing devices 102, the processing devices 120, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the web server 104 over the communication network 118. For example, each of the multiple computing devices 110, 112, 114 may be operable to view, access, and interact with a website, such as a retailer's website, hosted by the web server 104.

In some examples, the web server 104 can obtain various text items or documents, e.g. based on interactions with the website by the users operating the user computing devices 110, 112, 114. For example, when the website is a retailer website, the documents may include: product descriptions, seller profiles, advertisements, advertising campaigns, purchase orders or records, customer comments or reviews, etc. The web server 104 can transmit these documents to the topic computing device 102 over the communication network 118, and/or store the documents to the databases 116.

To quickly understand and better categorize a document, the web server 104 may transmit a topic identification request to the topic computing device 102, e.g. upon obtaining or generating the document or upon a pre-configured periodic topic identification job. The topic identification request may be sent standalone or together with the document(s) to be understood or categorized. In some examples, the topic identification request may carry or indicate a corpus of documents for training a multi-resolution topic model at the topic computing device 102. In some examples, the topic identification request may carry or indicate an inference document for identifying topics of the inference document based on the trained multi-resolution topic model at the topic computing device 102.

In some examples, the topic computing device 102 may execute one or more models (e.g., algorithms), such as a machine learning model, deep learning model, statistical model, etc., to determine topics for a document. In some examples, the topic computing device 102 may utilize a multi-resolution topic model that comprises various models to identify the topics for the document. For example, the topic computing device 102 can generate embeddings for the sentences in the document, and input the embeddings into multiple topic models to identify topics. Then, for each identified topic, the topic computing device 102 can generate topic related data, which may include sample sentences, topic name, topic description, etc. The topic computing device 102 may use a primary and secondary topic selector to select a primary model from the multiple topic models, where the remaining topic models are secondary models. The topic computing device 102 may identify primary topics determined based on the primary model, and identify, if any, qualified secondary topics that are determined based on some secondary models and are non-overlapping with any primary topic. For each of the primary topics and the qualified secondary topics, the topic computing device 102 may store its topic related data into the databases 116, and/or transmit to the topic related data to the web server 104, as a response to the topic identification request.

The topic computing device 102 is further operable to communicate with the databases 116 over the communication network 118. For example, the topic computing device 102 can store data to, and read data from, the databases 116. Each database in the databases 116 can be a remote storage device, such as a cloud-based server, a disk (e.g., a hard disk), a memory device on another application server, a networked computer, or any other suitable remote storage. Although shown remote to the topic computing device 102, in some examples, any database of the databases 116 can be a local storage device, such as a hard drive, a non-volatile memory, or a USB stick.

The databases 116 may further include a topic database 161 to store topic related data associated with identified topics; an embedding model database 162 to store machine learning models that convert text strings into numerical embedding representations; a topic model database 163 to store topic models or algorithms that can identify a topic associated with a data item like a document by applying machine learning models to the document; a similarity model database 164 to store similarity models or algorithms that can be used to compute similarity scores between two topic models; and a cluster comparison model database 165 to store cluster comparison models or algorithms that can be used to compare different clusters, e.g. different topics or different topic models.

In some examples, the topic computing device 102 generates training data for a plurality of models (e.g., machine learning models, deep learning models, statistical models, algorithms, etc.) based on a corpus of documents obtained from the web server 104 or the databases 116. The topic computing device 102 trains the models based on their corresponding training data, and stores the models in a database, such as in the databases 116 (e.g., a cloud storage).

The models, when executed by the topic computing device 102, allow the topic computing device 102 to determine topics for any text item or document, and generate topic related data accordingly to annotate or label this document. In some examples, the topic computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the topic computing device 102 may identify topics and generate topic related data.

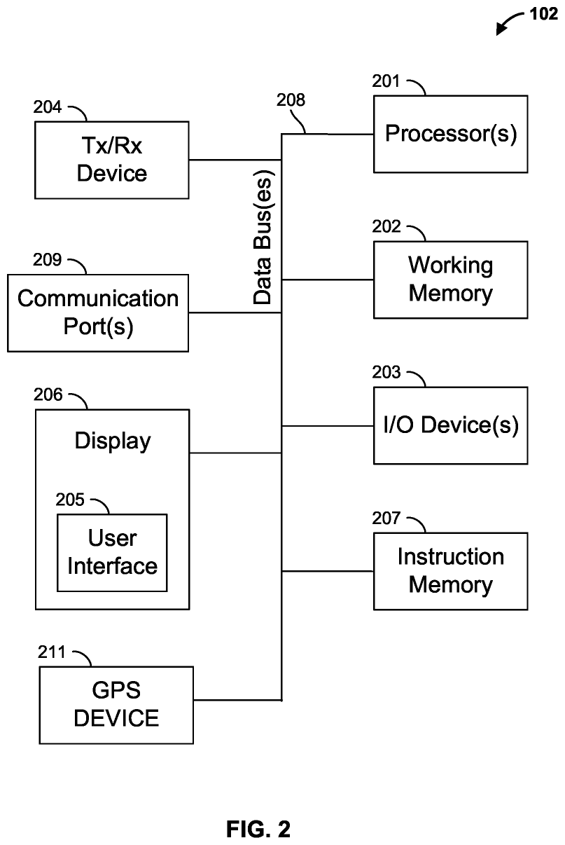

FIG. 2 illustrates a block diagram of a topic computing device, e.g. the topic computing device 102 of FIG. 1, in accordance with some embodiments of the present teaching. In some embodiments, each of the topic computing device 102, the web server 104, the multiple user computing devices 110, 112, 114, and the one or more processing devices 120 in FIG. 1 may include the features shown in FIG. 2. Although FIG. 2 is described with respect to certain components shown therein, it will be appreciated that the elements of the topic computing device 102 can be combined, omitted, and/or replicated. In addition, it will be appreciated that additional elements other than those illustrated in FIG. 2 can be added to the topic computing device 102.

As shown in FIG. 2, the topic computing device 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the topic computing device 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the topic computing device 102 can include a single memory unit configured to operate as both instruction memory and working memory. Further, although embodiments are discussed herein including non-volatile memory, it will be appreciated that computing device 50 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the topic computing device 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the topic computing device 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the topic computing device 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the topic computing device 102 and/or the web server 104. For example, the user interface 205 can be a user interface for an application of a network environment operator that allows a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the topic computing device 102 may determine a local geographical area (e.g., town, city, state, etc.) of its position.

In some embodiments, the topic computing device 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

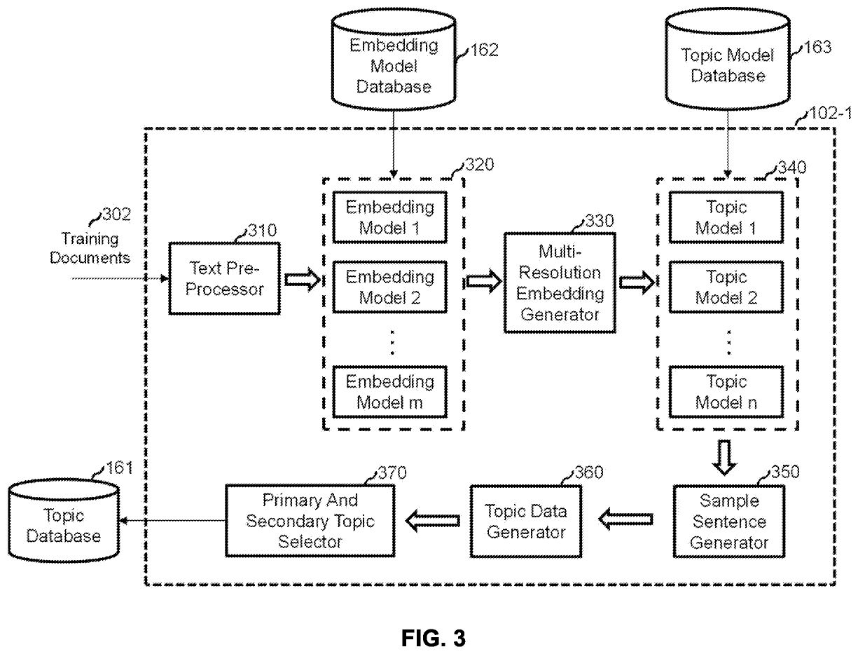

FIG. 3 illustrates a block diagram showing various portions of a topic computing device 102-1, which may be the topic computing device 102 in FIG. 1 during a training stage, in accordance with some embodiments of the present teaching. In some embodiments, upon a request, the topic computing device 102-1 can obtain at least one document, and apply a plurality of topic models to the at least one document to identify at least one topic associated with the at least one document. By selecting a topic model from the plurality of topic models based on the at least one topic, the topic computing device 102-1 can generate topic related data comprising data associated with a topic identified based on the selected topic model, and store the topic related data in a database.

In the example shown in FIG. 3, during a training stage, the topic computing device 102-1 may include and utilize a text pre-processor 310, a multi-resolution embedding generator 330, a sample sentence generator 350, a topic data generator 360, and a primary and secondary topic selector 370. These components can work together with various models, e.g. obtained from the databases 116, to identify topics and generate topic related data. In some examples, one or more of the text pre-processor 310, the multi-resolution embedding generator 330, the sample sentence generator 350, the topic data generator 360, the primary and secondary topic selector 370 and any model in FIG. 3, can be implemented in hardware. In some examples, one or more of the text pre-processor 310, the multi-resolution embedding generator 330, the sample sentence generator 350, the topic data generator 360, the primary and secondary topic selector 370 and any model in FIG. 3 are implemented as an executable program maintained in a tangible, non-transitory memory, such as instruction memory 207 of FIG. 2, which may be executed by one or processors, such as the processor 201 of FIG. 2.

As shown in FIG. 3, the text pre-processor 310 is configured to receive one or more training documents 302. In some embodiments, the training documents 302 may be received from the web server 104, together with a topic identification request. The training documents 302 may include text information associated with a website or its owner's business. The training documents 302 may contain sentences to be clustered or topic modelled into different topics.

The text pre-processor 310 in this example may perform basic to advanced preprocessing methods like Lemma, stop words removal, HTML tags removal, number removal, and word spelling correction. Based on these text preprocessing methods, the training documents 302 will be split into text-wise sentences. The text pre-processor 310 may then send the sentences to a plurality of embedding models 320.

As shown in FIG. 3, the plurality of embedding models 320 may be obtained from the embedding model database 162. Each of the plurality of embedding models 320 can be used to generate sentence embeddings for the sentences extracted from the training documents 302. The multi-resolution embedding generator 330 in this example can combine and fuse the embeddings generated by the plurality of embedding models 320, e.g. by removing replicate embeddings, to generate a set of multi-resolution embeddings. The multi-resolution embedding generator 330 may then send the set of multi-resolution embeddings to at least one of a plurality of topic models 340. In some embodiments, the multi-resolution embeddings may be used to train the plurality of topic models 340 that are based on either document-term matrix or clustering.

The plurality of topic models 340 may be obtained from the topic model database 163. Each of the plurality of topic models 340 can be used to identify one or more topics for the sentences extracted from the training documents 302. In some embodiments, the plurality of topic models 340 may include topic models identifying topics based on a document-term matrix, e.g. topic models like non-negative matrix factorization (NMF), latent Dirichlet allocation (LDA); and/or topic models identifying topics based on embeddings or clustering, e.g. topic models like hierarchical density-based spatial clustering for applications with noise (HDBSCAN), K-Means clustering. In some embodiments, the text pre-processor 310 may generate a document-term matrix (DTM) based on the training documents 302, and send the DTM to at least one topic model, among the plurality of topic models 340, utilizing the DTM to identify topics. In some embodiments, the multi-resolution embedding generator 330 may send the multi-resolution embeddings to at least one topic model, among the plurality of topic models 340, utilizing the embeddings to identify topics.

The sample sentence generator 350 in this example can generate and collect K sample sentences to represent each topic identified by each topic model, where K can be any positive integer. For example, for each topic, the sample sentence generator 350 can generate or collect ten best sentences that can represent the topic.

The topic data generator 360 in this example can create topic data, e.g. topic name, topic description, or any other topic labeling information for each identified topic. The topic data generator 360 may label each topic based on the sample sentences associated with the topic. In some embodiments, the topic data generator 360 may generate the topic data based on at least one of the following methods: summarization, question-answering, n-chunk and bag-of-words. In some embodiments, the topic data generator 360 may create an output file for each identified topic, where the output file includes information about: the topic, the topic model identifying the topic, and topic related data associated with the topic, including sample sentences, topic name, topic description, etc.

The primary and secondary topic selector 370 in this example may read the files for the identified topics, and select primary and secondary topics. The primary and secondary topic selector 370 may select a primary topic model from the plurality of topic models 340, where topics identified for the training documents 302 based on the primary topic model are called primary topics. The remaining topic models other than the primary topic model among the plurality of topic models 340 are secondary topic models, where topics identified for the training documents 302 based on the secondary topic models are called secondary topics.

In some embodiments, the primary and secondary topic selector 370 can compute, for each respective topic model of the plurality of topic models 340, an overlapping score indicating a level of overlap between topics identified based on the respective topic model and topics identified based on the remaining topic models of the plurality of topic models. The plurality of topic models 340 may be ranked based on their respective overlapping scores. As such, the primary and secondary topic selector 370 can select the primary topic model as a topic model having the highest overlapping score among the plurality of topic models 340. That is, the primary topic model generates topics overlapping the most with topics from other topic models.

The primary and secondary topic selector 370 can store each primary topic and its associated topic related data to the topic database 161, e.g. as an output file described above. In addition, the primary and secondary topic selector 370 can determine whether there is any qualified secondary topic non-overlapping with the primary topics. If so, the primary and secondary topic selector 370 can identify each qualified secondary topic, and store its corresponding output file to the topic database 161.

In some embodiments, the plurality of topic models 340 fused by the primary and secondary topic selector 370 can be treated as a multi-resolution topic model to capture all topics of the training documents 302, while removing redundant topics identified by the plurality of topic models 340. The topic computing device 102-1 in this example does not have to store the entire multi-resolution topic model. For example, the topic computing device 102-1 may just store the primary topics, any qualified secondary topic, and topic related data associated with each stored topic.

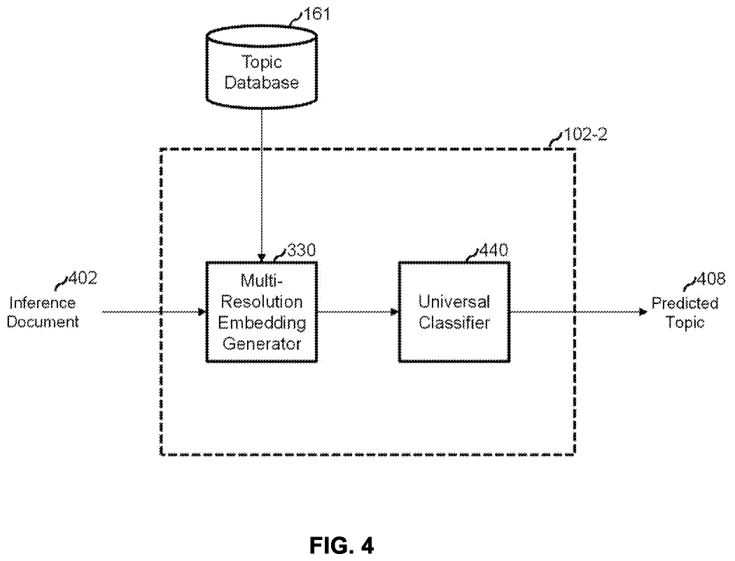

In some embodiments, the topic computing device 102-1 may assign one or more of the operations described above to a different processing unit or virtual machine hosted by the one or more processing devices 120. Further, the topic computing device 102-1 may obtain the outputs of the these assigned operations from the processing units, identify topics and generate topic related data based on the outputs. In some embodiments, the topic identification request from the web server 104 can indicate whether to re-train the multi-resolution topic model based on some new training documents as described above regarding FIG. 3, or to predict topics for an inference document to be described below regarding FIG. 4.

FIG. 4 illustrates a block diagram showing various portions of a topic computing device 102-2, which may be the topic computing device 102 in FIG. 1 during an inference stage, in accordance with some embodiments of the present teaching. In some embodiments, upon a request, the topic computing device 102-2 may obtain an inference document, and retrieve the previously stored topic related data from the database 161. The topic computing device 102-2 can generate first sentence embeddings for sentences in the inference document; generate second sentence embeddings for sample sentences in the topic related data; and apply a few-shot classifier to the first sentence embeddings and the second sentence embeddings to identify at least one predicted topic for the inference document.

In the example shown in FIG. 4, during an inference stage, the topic computing device 102-2 may include and utilize the multi-resolution embedding generator 330 and a universal classifier 440. In some examples, one or more of the multi-resolution embedding generator 330 and the universal classifier 440 are implemented in hardware. In some examples, one or more of the multi-resolution embedding generator 330 and the universal classifier 440 are implemented as an executable program maintained in a tangible, non-transitory memory, such as instruction memory 207 of FIG. 2, which may be executed by one or processors, such as the processor 201 of FIG. 2.

As shown in FIG. 4, the multi-resolution embedding generator 330 in the topic computing device 102-2 during the inference stage may receive an inference text item or inference document 402. In some embodiments, the inference document 402 may be received from the web server 104, together with a topic identification request. The inference document 402 may include text information associated with a website or its owner's business, e.g. based on a newly submitted or generated product description, seller profile, advertisement, purchase order, or customer review. The inference document 402 may contain sentences to be clustered or topic modelled into different topics.

The multi-resolution embedding generator 330 may retrieve the output files from the topic database 161, including sample sentences for each stored topic associated with its respective topic model. Working in parallel, the multi-resolution embedding generator 330 may generate first sentence-level embeddings for the non-labelled inference document 402, and generate or retrieve second sentence-level embeddings for the sample sentences from the output files. The multi-resolution embedding generator 330 can send the first sentence-level embeddings and the second sentence-level embeddings to the universal classifier 440 to predict topics for the inference document 402. As such, the topic computing device 102-2 does not need to store or retrieve any one of the plurality of topic models 340 to predict topics for an inference document.

The universal classifier 440 in this example may be a few-shot learner, that can classify the inference document 402, e.g. by comparing the first sentence-level embeddings to the second sentence-level embeddings, and predicting one or more topics for the inference document 402 based on the stored topics and the relative positions of the first sentence-level embeddings with respect to the second sentence-level embeddings in the embedding space.

As discussed above, the primary and secondary topic selector 370 in FIG. 3 is configured to select a primary topic model that overlaps the most with other topic models in terms of topic overlapping; and select only non-overlapping topics from the secondary topic models. To achieve these goals, the primary and secondary topic selector 370 may execute in three phases. In a first phase, the primary and secondary topic selector 370 can rank the topic models based on some similarity scores to find the primary topic model. In a second phase, the primary and secondary topic selector 370 can check for availability of non-overlapping topics from the secondary topic models. In a third phase, the primary and secondary topic selector 370 can find the non-overlapping topics from the secondary topic models.

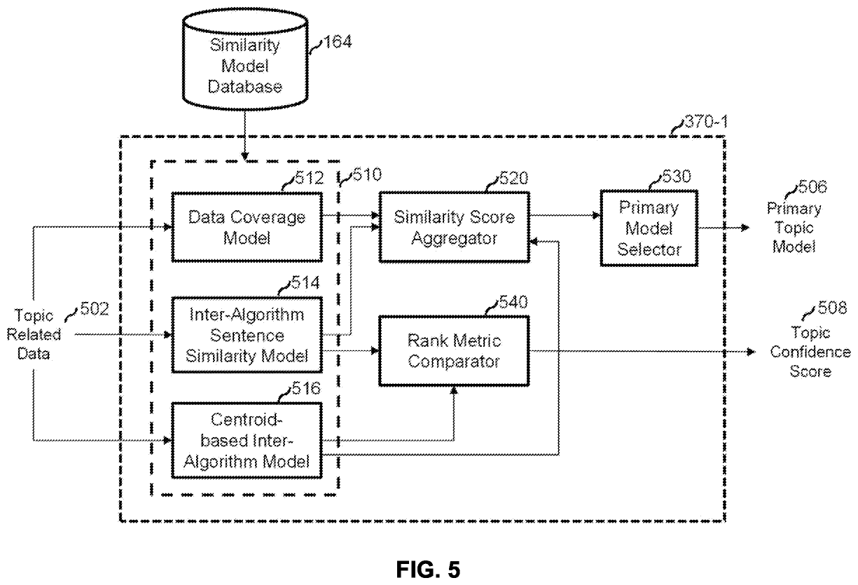

FIG. 5 illustrates a block diagram of a primary and secondary topic selector 370-1, which may be the primary and secondary topic selector 370 in FIG. 3 operating in a first phase, in accordance with some embodiments of the present teaching. In the example shown in FIG. 5, in the first phase, the primary and secondary topic selector 370-1 may include and utilize a similarity score aggregator 520, a primary model selector 530, and a rank metric comparator 540. These components can work together with a plurality of similarity models 510, e.g. obtained from the similarity model database 164, to select a primary topic model identifying most overlapping topics and compute a topic confidence score. In some examples, one or more of the similarity score aggregator 520, the primary model selector 530, the rank metric comparator 540 and any model in FIG. 5 can be implemented in hardware. In some examples, one or more of the similarity score aggregator 520, the primary model selector 530, the rank metric comparator 540 and any model in FIG. 5 are implemented as an executable program maintained in a tangible, non-transitory memory, such as instruction memory 207 of FIG. 2, which may be executed by one or processors, such as the processor 201 of FIG. 2.

As shown in FIG. 5, the plurality of similarity models 510 may be obtained from the similarity model database 164. Each of the plurality of similarity models 510 can receive topic related data 502, e.g. from the topic data generator 360 in FIG. 3, regarding the plurality of topic models 340. In some embodiments, the topic related data 502 may include information about: topics, topic models identifying the topics, sample sentences, topic names, and topic descriptions associated with the topics. The topic related data 502 may be obtained from the output files generated by the topic data generator 360.

In the example of FIG. 5, the plurality of similarity models 510 includes: a data coverage (DC) model 512, an inter-algorithm sentence similarity (IASS) model 514, and a centroid-based inter-algorithm (CIA) model 516. In some embodiments, the DC model 512 may be used to generate a model-wise similarity score for each topic model based on the number of topics and a data set size. For example, the DC model 512 can be used to compute a first score for each topic model, proportional to a ratio between (a) a quantity of topics identified based on the topic model and (b) a sum of total data points in a corpus.

In some embodiments, each topic model will provide one or more topics, each topic being treated as a cluster. As such, the DC model 512 can be used to compute the first score according to the number of clusters formed. For example, when topic models A1, A2, A3, A4 have: 6 clusters, 10 clusters, 11 cluster, and 3 cluster respectively, the first scores for these topic models are 0.20, 0.33, 0.37, and 0.10 and the ranking for the topic models is [A3, A2, A1, A4] according to the first scores. That is, topic model A3 in this example is ranked the best among the four topic models, as having topics overlapping the most with other topics of other topic models. The first score or DC score can indicate how well a topic model sees the difference inside a given dataset. In some embodiments, the DC scores for the topic models and/or a ranking of the topic models based on the DC scores, can be sent to the similarity score aggregator 520 for generating aggregated similarity scores.

In some embodiments, the IASS model 514 may be used to generate an inter-model similarity score for each topic model by comparing embeddings for each detailed topic descriptions of the topic model with other topics of other topic models. For example, the IASS model 514 can be used to compute a second score for each respective topic model based on a topic name or a topic description generated for each topic identified based on the respective topic model. The topic models can be ranked based on the second scores.

In some examples, a method to compute the second score or IASS score for a respective topic model may include: for each remaining topic model of the plurality of topic models, determining a plurality of topic pairs based on each topic identified based on the respective topic model and each topic identified based on the remaining topic model, wherein each topic pair includes a first respective topic identified based on the respective topic model and a second respective topic identified based on the remaining topic model; computing, for each topic pair, a first similarity score indicating a similarity between (a) an embedding for a topic name or a topic description generated for the first respective topic identified based on the respective topic model and (b) an embedding for a topic name or a topic description generated for the second respective topic identified based on the remaining topic model; and computing, for the respective topic model with respect to the remaining topic model, a second similarity score based on a combination of all first similarity scores computed for the plurality of topic pairs. Then for the respective topic model, the second score can be computed based on a combination of all second similarity scores computed with respect to all remaining topic models of the plurality of topic models.

For example, CosSim (Ai_Tk, Aj_Tl) can be used to represent a cosine similarity between two embeddings: an embedding of topic name or description for topic k of topic modelling algorithm i, and an embedding of topic name or description for topic l of topic modelling algorithm j. Based on the IASS model 514, an IASS score of A1_T1 with respect to A2 can be computed based on an average or weighted combination of: CosSim (A1_T1, A2_T1), CosSim (A1_T1, A2_T2) . . . . CosSim (A1_T1, A2_Tn2), assuming A2 identified n2 topics. Then, an IASS score of A1 with respect to A2 can be computed based on an average or weighted combination of: the IASS score of A1_T1 with respect to A2, the IASS score of A1_T2 with respect to A2 . . . the IASS score of A1_Tn1 with respect to A2, assuming A1 identified n1 topics. Then, an IASS score of A1 can be computed based on an average or weighted combination of: the IASS score of A1 with respect to A2, the IASS score of A1 with respect to A3 . . . the IASS score of A1 with respect to An, assuming there are in total n topic models or modelling algorithms, e.g. in the plurality of topic models 340, used to identify topics. Based on the IASS scores of the topic models A1, A2. . . . An, the plurality of topic models 340 can be ranked based on an IASS ranking according to their respective IASS scores. In some embodiments, the IASS scores for the topic models can be sent to the similarity score aggregator 520 for generating aggregated similarity scores; while the IASS ranking can be sent to the rank metric comparator 540 for ranking comparison.

In some embodiments, the CIA model 516 may be used to generate a centroid-based inter-model similarity score for each topic model by comparing centroids of sample sentences for the topic model with those for other topics of other topic models. For example, the CIA model 516 can be used to compute third score based on at least one sample sentence generated for each topic identified based on the respective topic model. The topic models can be ranked based on the third scores.

In some examples, a method to compute the third score or CIA score for a respective topic model may include: for each remaining topic model of the plurality of topic models, determining a plurality of topic pairs based on each topic identified based on the respective topic model and each topic identified based on the remaining topic model, wherein each topic pair includes a third respective topic identified based on the respective topic model and a fourth respective topic identified based on the remaining topic model; computing, for each topic pair, a third similarity score indicating a similarity between (a) a centroid of embeddings of sample sentences generated for the third respective topic identified based on the respective topic model and (b) a centroid of embeddings of sample sentences generated for the fourth respective topic identified based on the remaining topic model; and computing, for the respective topic model with respect to the remaining topic model, a fourth similarity score based on a combination of all third similarity scores computed for the plurality of topic pairs. Then, for the respective topic model, the third score is computed based on a combination of all fourth similarity scores computed with respect to all remaining topic models of the plurality of topic models. A centroid of embeddings is a central point of the embeddings in the embedding space.

For example, CosSim (Ai_Tk_c, Aj_Tl_c) can be used to represent a cosine similarity between two centroids: a centroid of embeddings of sample sentences generated for topic k of topic modelling algorithm i, and a centroid of embeddings of sample sentences generated for topic l of topic modelling algorithm j. Based on the CIA model 516, a CIA score of A1_T1 with respect to A2 can be computed based on an average or weighted combination of: CosSim (A1_T1_c, A2_T1_c), CosSim (A1_T1, A2_T2_c) . . . . CosSim (A1_T1, A2_Tn2_c), assuming A2 identified n2 topics. Then, a CIA score of A1 with respect to A2 can be computed based on an average or weighted combination of: the CIA score of A1_T1 with respect to A2, the CIA score of A1_T2 with respect to A2 . . . the CIA score of A1_Tn1 with respect to A2, assuming A1 identified n1 topics. Then, a CIA score of A1 can be computed based on an average or weighted combination of: the CIA score of A1 with respect to A2, the CIA score of Al with respect to A3 . . . the CIA score of A1 with respect to An, assuming there are in total n topic models or modelling algorithms, e.g. in the plurality of topic models 340, used to identify topics. Based on the CIA scores of the topic models A1, A2. . . . An, the plurality of topic models 340 can be ranked based on a CIA ranking according to their respective CIA scores. In some embodiments, the CIA scores for the topic models can be sent to the similarity score aggregator 520 for generating aggregated similarity scores; while the CIA ranking can be sent to the rank metric comparator 540 for ranking comparison.

The similarity score aggregator 520 in this example may collect DC scores from the DC model 512, the IASS scores from the IASS model 514, and the CIA scores from the CIA model 516. Then, the similarity score aggregator 520 can compute an aggregated similarity score for each topic model, based on a weighted combination of the DC score, IASS score, and CIA score of the topic model. In some embodiments, the aggregated similarity score is an overlapping score computed based on a weighted summation of the first score, the second score and the third score as discussed above. Based on the aggregated similarity scores for the plurality of topic models 340 including both embedding based topic models and DTM based topic models, the primary model selector 530 can select a primary topic model 506 from the plurality of topic models 340. The primary topic model 506 has the highest aggregated similarity score or overlapping score among the plurality of topic models 340.

The rank metric comparator 540 in this example can obtain the IASS ranking from the IASS model 514 and the CIA ranking from the CIA model 516. By comparing the IASS ranking and the CIA ranking, the rank metric comparator 540 can cross verify these rankings and generate a topic confidence score 508. The topic confidence score 508 is a validation score that can be used to determine whether topic descriptions are reliable to be used later.

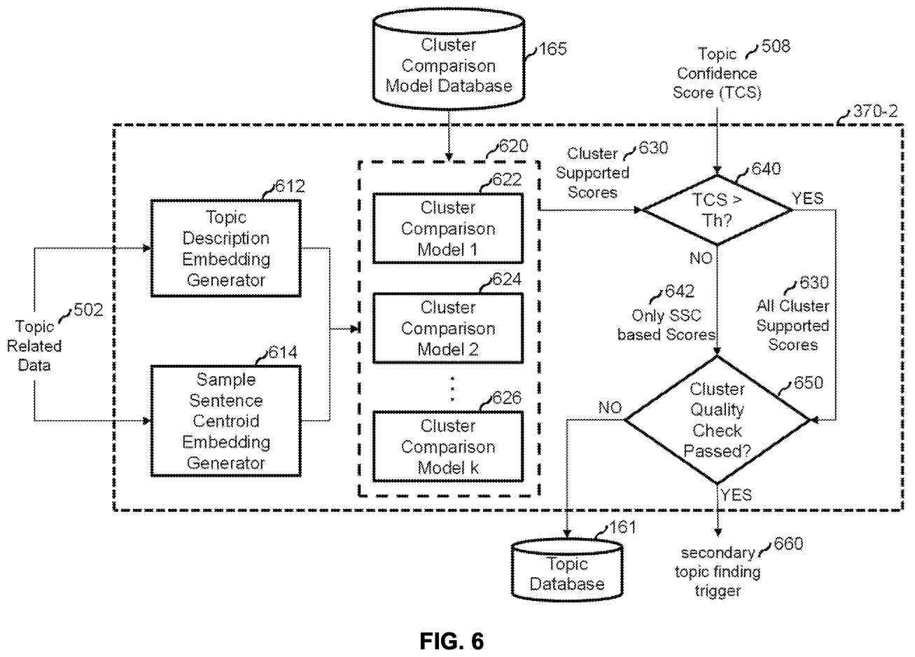

FIG. 6 illustrates a block diagram of a primary and secondary topic selector 370-2, which may be the primary and secondary topic selector 370 in FIG. 3 operating in a second phase in accordance with some embodiments of the present teaching. In the example shown in FIG. 6, in the second phase, the primary and secondary topic selector 370-2 may include and utilize a topic description embedding generator 612 and a sample sentence centroid embedding generator 614. These components can work together with a plurality of cluster comparison models 620, e.g. obtained from the cluster comparison model database 165, to check whether to eliminate all topics from secondary topic models or add one or more topics from the secondary topic models. In some examples, one or more of the topic description embedding generator 612, the sample sentence centroid embedding generator 614 and any model in FIG. 6 can be implemented in hardware. In some examples, one or more of the topic description embedding generator 612, the sample sentence centroid embedding generator 614 and any model in FIG. 6 are implemented as an executable program maintained in a tangible, non-transitory memory, such as instruction memory 207 of FIG. 2, which may be executed by one or processors, such as the processor 201 of FIG. 2.

As shown in FIG. 6, each of the topic description embedding generator 612 and the sample sentence centroid embedding generator 614 may receive the topic related data 502, e.g. from the topic data generator 360 in FIG. 3, regarding the plurality of topic models 340. In some embodiments, the topic related data 502 may be obtained from the output files generated by the topic data generator 360.

The topic description embedding generator 612 in this example can generate or collect embeddings of topic descriptions for the identified topics in the topic related data 502. The topic description embedding generator 612 may treat each topic model as a cluster where data points are topic description (TD) embeddings. For example, the topic description embedding generator 612 can generate, for each respective topic model of the plurality of topic models, a first cluster including embedding points each representing a topic description generated for a respective topic identified based on the respective topic model.

The sample sentence centroid embedding generator 614 in this example can generate or collect centroid embeddings of sample sentences for each identified topic in the topic related data 502. The sample sentence centroid embedding generator 614 may treat each topic model as a cluster where data points are sample sentence centroids (SSC). For example, the sample sentence centroid embedding generator 614 can generate, for each respective topic model of the plurality of topic models, a second cluster including embedding points each being a centroid of embeddings of sample sentences generated for a respective topic identified based on the respective topic model.

In some embodiments, the plurality of cluster comparison models 620 are obtained from the cluster comparison model database 165 and applied to clusters generated by the topic description embedding generator 612 and the sample sentence centroid embedding generator 614 to compute cluster supported scores 630. In some embodiments, each of the plurality of cluster comparison models 620 is applied to: both the first clusters corresponding to the plurality of topic models to generate a first plurality of cluster supported scores, and the second clusters corresponding to the plurality of topic models to generate a second plurality of cluster supported scores. The cluster supported scores 630 include the first plurality of cluster supported scores (TD based scores) and the second plurality of cluster supported scores (SSC based scores).

In some embodiments, the plurality of cluster comparison models 620 include: a cluster comparison model 1 622, which may be based on Silhouette Coefficient; a cluster comparison model 2 624, which may be based on Davies-Bouldin Index; a cluster comparison model k 626, which may be based on Calinski-Harabasz Index. In various embodiments, k can be any positive integer. Each of the plurality of cluster comparison models 620 may be used to compare the cluster generated for the primary topic model where data points are from TD embeddings and SSC embeddings with the similar clusters generated for the secondary topic models.

At operation 640, the primary and secondary topic selector 370-2 can obtain the topic confidence score (TCS) 508 and compare it with a predetermined threshold. The TCS 508 may be computed as discussed above in the first phase regarding FIG. 5. If the TCS 508 is larger than the predetermined threshold, all cluster supported scores 630 generated by the plurality of cluster comparison models 620 will be sent to operation 650 for a cluster quality check. If the TCS 508 is not larger than the predetermined threshold, only SSC based scores 642 generated by the plurality of cluster comparison models 620 for clusters of sample sentence centroids will be sent to the operation 650 for a cluster quality check. The operation 640 can determine whether TD based scores are reliable to consider or not.

At the operation 650, the primary and secondary topic selector 370-2 can compare each cluster supported score to a respective threshold to determine whether a respective condition is met. As discussed above, the primary and secondary topic selector 370-2 can separately consider conditions for TD based clusters and SSC based clusters. When all cluster supported scores 630 are sent for cluster quality check at the operation 650, the primary and secondary topic selector 370-2 determines whether a secondary topic finding process is triggered based on whether each condition regarding each cluster supported score is met. When only SSC based scores 642 are sent for cluster quality check at the operation 650, the primary and secondary topic selector 370-2 determines whether the secondary topic finding process is triggered based on whether each condition regarding each SSC based score is met.

In some embodiments, if all conditions are passed at the operation 650, the primary and secondary topic selector 370 can enter the third phase, by generating a secondary topic finding trigger 660. Otherwise, the primary and secondary topic selector 370 does not enter the third phase, and only topics from the primary topic model are stored into the topic database 161.

In some embodiments, if K conditions out of the total conditions are passed at the operation 650, the primary and secondary topic selector 370 can enter the third phase, by generating the secondary topic finding trigger 660. Otherwise, the primary and secondary topic selector 370 does not enter the third phase, and only topics from the primary topic model are stored into the topic database 161. K can be any positive integer.

In some embodiments, when it is determined the secondary topic finding process is triggered or when the primary and secondary topic selector 370-2 generates the secondary topic finding trigger 660, the primary and secondary topic selector 370-2 can determine that there is at least one secondary topic that is identified by a secondary topic model and is non-overlapping with any primary topic identified by the primary topic model.

In some examples, the plurality of cluster comparison models 620 includes three cluster comparison models: Silhouette, Davies-Bouldin, Calinski-Harabasz. A Silhouette score is in the range of [−1,1], with −1 representing worst clustering (the clusters have most overlapping) and +1 representing best clusters (the clusters have no overlapping). A Davies-Bouldin score has a minimum value of zero, where a lower Davies-Bouldin score indicates better clustering. A Calinski-Harabasz score may be determined as a ratio between the within-cluster dispersion and the between-cluster dispersion, where a higher Calinski-Harabasz score indicates better clustering. In some examples, a default threshold of 0 is set for the Silhouette scores during the cluster quality check, such that a cluster quality check for a Silhouette score is passed if the Silhouette score is larger than 0. In some examples, a default threshold of 3 is set for the Davies-Bouldin scores during the cluster quality check, such that a cluster quality check for a Davies-Bouldin score is passed if the Davies-Bouldin score is less than 3. In some examples, a default threshold of 3 is set for the Calinski-Harabasz scores during the cluster quality check, such that a cluster quality check for a Calinski-Harabasz score is passed if the Calinski-Harabasz score is larger than 3. In some embodiments, if all cluster quality checks are passed, the primary and secondary topic selector 370 can enter the third phase, by generating the secondary topic finding trigger 660. In some embodiments, if two out of the three cluster quality checks are passed at the operation 650, the primary and secondary topic selector 370 can enter the third phase, by generating the secondary topic finding trigger 660. In some embodiments, if one out of the three cluster quality checks is passed at the operation 650, the primary and secondary topic selector 370 can enter the third phase, by generating the secondary topic finding trigger 660.

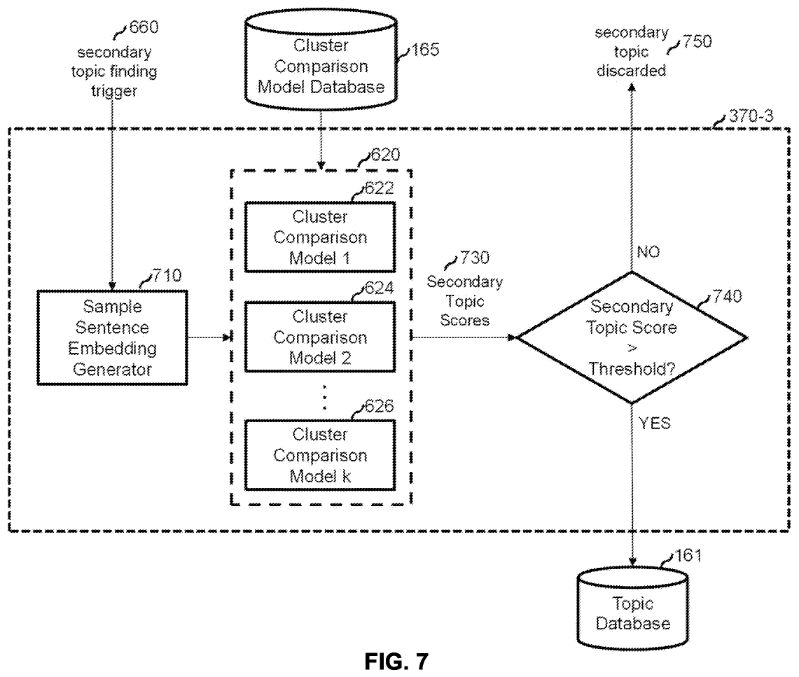

FIG. 7 illustrates a block diagram of a primary and secondary topic selector 370-3, which may be the primary and secondary topic selector 370 in FIG. 3 operating in a third phase in accordance with some embodiments of the present teaching. In the example shown in FIG. 7, in the third phase, the primary and secondary topic selector 370-3 may include and utilize a sample sentence embedding generator 710 that can work together with the plurality of cluster comparison models 620, e.g. obtained from the cluster comparison model database 165, to find one or more topics from the secondary topic models to supplement the primary topics. In some examples, one or more of the sample sentence embedding generator 710 and any model in FIG. 7 can be implemented in hardware. In some examples, one or more of the sample sentence embedding generator 710 and any model in FIG. 7 are implemented as an executable program maintained in a tangible, non-transitory memory, such as instruction memory 207 of FIG. 2, which may be executed by one or processors, such as the processor 201 of FIG. 2.

As shown in FIG. 7, the sample sentence embedding generator 710 may receive the secondary topic finding trigger 660, which may be generated based on the cluster quality check in FIG. 6 during the second phase. The secondary topic finding trigger 660 indicates that some quality secondary topic is identified by a secondary topic model. The purpose of the third phase is to find the secondary topics that are not overlapping with the primary topics, based on sentence-level embeddings.

In response to the secondary topic finding trigger 660, the sample sentence embedding generator 710 may generate, for each respective topic identified based on each respective topic model of the plurality of topic models, a third cluster including sentence-level embeddings representing every sample sentence generated for the respective topic associated with the training documents 302. The embeddings generated by the sample sentence embedding generator 710 are for sample sentences, rather than a centroid. Each cluster generated by the sample sentence embedding generator 710 represents a topic, rather than a topic model.

The plurality of cluster comparison models 620 in the primary and secondary topic selector 370-3 are used to compare topic-level clusters in the primary topic model with topic-level clusters in the secondary topic models, to generate secondary topic scores 730. For example, the primary and secondary topic selector 370-3 can compare primary topics identified based on the primary topic model to secondary topics identified based on the secondary topic models by applying the plurality of cluster comparison models 620 to the third clusters to generate a secondary topic score for each secondary topic. In some embodiments, the secondary topic scores can be computed based on cluster comparison models like Silhouette, Davies-Bouldin, and/or Calinski-Harabasz, in a similar manner as the cluster supported scores 630 in FIG. 6. In some embodiments, a secondary topic score for a secondary topic may be a weighted combination of the Silhouette score, Davies-Bouldin score, and Calinski-Harabasz score computed for the secondary topic, where a higher secondary topic score means the secondary topic is less overlapping with the other topics or topic-level clusters.

In some examples, for each secondary topic (or topic-level cluster) of each secondary topic model, the plurality of cluster comparison models 620 may be applied to the secondary topic and all primary topics of the primary topic model, to compare the secondary topic with the primary topics. Based on this comparison, a secondary topic score is generated for the secondary topic to indicate whether or how much the secondary topic is overlapping with the primary topics. In some examples, a higher secondary topic score means the secondary topic is less overlapping with the primary topics.

In some examples, for each secondary topic (or topic-level cluster) of each secondary topic model, the plurality of cluster comparison models 620 may be applied to the secondary topic and each primary topic of the primary topic model, to compare the secondary topic with the primary topic and generate an intermediate topic score. The secondary topic score for the secondary topic may be computed based on an average or weighted combination of all intermediate topic scores generated for the secondary topic with respect to all primary topics. In some examples, a higher secondary topic score means the secondary topic is less overlapping with the primary topics.

At operation 740, each secondary topic score for a corresponding secondary topic is compared to a threshold. If the secondary topic score is higher than the threshold, the corresponding secondary topic is determined to be a non-overlapping topic with respect to the primary topics, and is stored into the topic database 161 together with its topic related data. If the secondary topic score is not higher than the threshold, the corresponding secondary topic together with its topic related data is discarded and not stored into the topic database 161. In some embodiments, the primary and secondary topic selector 370-3 can identify at least one qualified secondary topic whose secondary topic score is higher than the threshold. As such, after the third phase, the primary and secondary topic selector 370-3 stores into the topic database 161: the primary topics, the at least one qualified secondary topic, and sample sentences generated for each of the primary topics and the at least one qualified secondary topic.

In some embodiments, after a first secondary topic is determined to be a non-overlapping topic with respect to the primary topics, the first secondary topic is combined with the primary topics when determining whether a second secondary topic should be discarded or added to the topic database 161. That is, the plurality of cluster comparison models 620 may be applied to the second secondary topic, the first secondary topic and all primary topics of the primary topic model, to compare the second secondary topic with respect to the first secondary topic and all primary topics. Based on this comparison, a secondary topic score is generated for the second secondary topic to indicate whether or how much the second secondary topic is overlapping with the first secondary topic and the primary topics. If the secondary topic score for the second secondary topic is higher than the threshold, the second secondary topic is stored into the topic database 161 together with its topic related data. Otherwise, the second secondary topic is discarded.

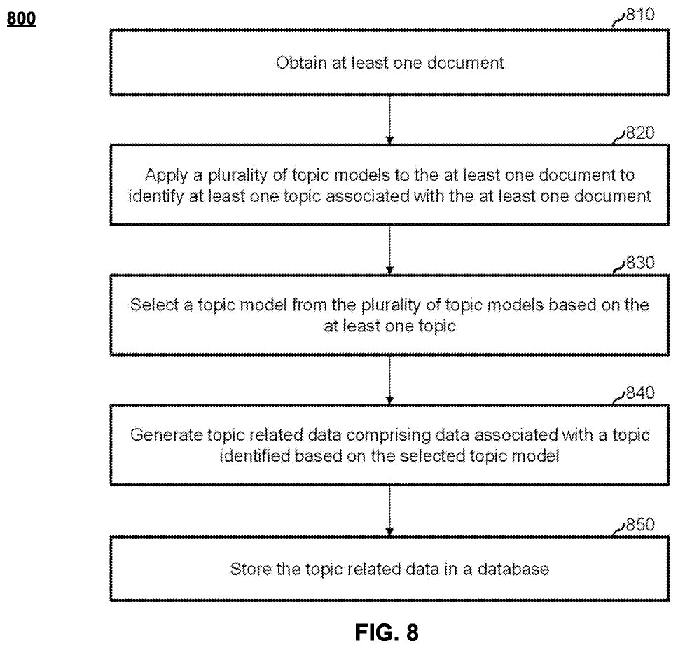

FIG. 8 is a flowchart illustrating an exemplary method 800 for determining topics based on selective topic models, in accordance with some embodiments of the present teaching. In some embodiments, the method 800 can be carried out by one or more computing devices, such as the topic computing device 102 and/or the cloud-based engine 121 of FIG. 1. Beginning at operation 810, at least one document is obtained. At operation 820, a plurality of topic models are applied to the at least one document to identify at least one topic associated with the at least one document. At operation 830, a topic model is selected from the plurality of topic models based on the at least one topic. Topic related data is generated at operation 840, where the topic related data may comprise data associated with a topic identified based on the selected topic model. The topic related data is stored in a database at operation 850.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory having instructions stored thereon; and
at least one processor operatively coupled to the non-transitory memory, and configured to read the instructions to:
obtain at least one document,
apply a plurality of topic models to the at least one document to identify at least one topic associated with the at least one document,
select a topic model from the plurality of topic models based on the at least one topic,
generate topic related data comprising data associated with a topic identified based on the selected topic model, and
store the topic related data in a database.

2. The system of claim 1, wherein the at least one processor is configured to read the instructions to:
pre-process the at least one document to split the at least one document into a plurality of sentences;
compute at least embedding for each of the plurality of sentences to generate a plurality of embeddings; and
generate a document-term matrix based on the at least one document.

3. The system of claim 2, wherein the plurality of topic models comprises:
at least one topic model configured to identify a topic associated with the at least one document based on the plurality of embeddings; and
at least one topic model configured to identify a topic associated with the at least one document based on the document-term matrix.

4. The system of claim 1, wherein the selected topic model is selected based on:
computing, for each respective topic model of the plurality of topic models, an overlapping score indicating a level of overlap between topics identified based on the respective topic model and topics identified based on the remaining topic models of the plurality of topic models;
ranking the plurality of topic models based on their respective overlapping scores; and
selecting the topic model as a primary topic model that has the highest overlapping score among the plurality of topic models, wherein the plurality of topic models comprises the primary topic model and at least one secondary topic model.

5. The system of claim 4, wherein for each respective topic model of the plurality of topic models, computing the overlapping score comprises:
computing a first score based on (a) a quantity of topics identified based on the respective topic model and (b) a sum of quantities of topics identified based on the plurality of topic models;
computing a second score based on a topic name or a topic description generated for each topic identified based on the respective topic model;
computing a third score based on at least one sample sentence generated for each topic identified based on the respective topic model; and
computing the overlapping score based on a weighted summation of the first score, the second score and the third score.

6. The system of claim 5, wherein computing the second score comprises:
for each remaining topic model of the plurality of topic models,
determining a plurality of topic pairs based on each topic identified based on the respective topic model and each topic identified based on the remaining topic model, wherein each topic pair includes a first respective topic identified based on the respective topic model and a second respective topic identified based on the remaining topic model,
computing, for each topic pair, a first similarity score indicating a similarity between (a) an embedding for a topic name or a topic description generated for the first respective topic identified based on the respective topic model and (b) an embedding for a topic name or a topic description generated for the second respective topic identified based on the remaining topic model, and
computing, for the respective topic model with respect to the remaining topic model, a second similarity score based on a combination of all first similarity scores computed for the plurality of topic pairs; and
computing, for the respective topic model, the second score based on a combination of all second similarity scores computed with respect to all remaining topic models of the plurality of topic models.

7. The system of claim 5, wherein computing the third score comprises:
for each remaining topic model of the plurality of topic models,
determining a plurality of topic pairs based on each topic identified based on the respective topic model and each topic identified based on the remaining topic model, wherein each topic pair includes a third respective topic identified based on the respective topic model and a fourth respective topic identified based on the remaining topic model,
computing, for each topic pair, a third similarity score indicating a similarity between (a) a centroid of embeddings of sample sentences generated for the third respective topic identified based on the respective topic model and (b) a centroid of embeddings of sample sentences generated for the fourth respective topic identified based on the remaining topic model, and
computing, for the respective topic model with respect to the remaining topic model, a fourth similarity score based on a combination of all third similarity scores computed for the plurality of topic pairs; and
computing, for the respective topic model, the third score based on a combination of all fourth similarity scores computed with respect to all remaining topic models of the plurality of topic models.

8. The system of claim 5, wherein the at least one processor is configured to read the instructions to:
generate a first ranking of the plurality of topic models based on their respective second scores;
generate a second ranking of the plurality of topic models based on their respective third scores; and
determine a topic confidence score based on a comparison of the first ranking and the second ranking.

9. The system of claim 8, wherein the at least one processor is configured to read the instructions to:
generate, for each respective topic model of the plurality of topic models, a first cluster including embedding points each representing a topic description generated for a respective topic identified based on the respective topic model;
generate, for each respective topic model of the plurality of topic models, a second cluster including embedding points each being a centroid of embeddings of sample sentences generated for a respective topic identified based on the respective topic model;
apply a plurality of cluster comparison models to the first clusters corresponding to the plurality of topic models to generate a first plurality of cluster supported scores; and
apply the plurality of cluster comparison models to the second clusters corresponding to the plurality of topic models to generate a second plurality of cluster supported scores.

10. The system of claim 9, wherein the at least one processor is configured to read the instructions to:
determine whether the topic confidence score is larger than a predetermined threshold;
when the topic confidence score is larger than the predetermined threshold,
compare each of the first plurality of cluster supported scores to a respective first threshold to determine whether a first condition is met,
compare each of the second plurality of cluster supported scores to a respective second threshold to determine whether a second condition is met, and
determine whether a secondary topic finding process is triggered based on whether each of the first conditions and the second conditions is met;
when the topic confidence score is not larger than the predetermined threshold,
compare each of the second plurality of cluster supported scores to the respective second threshold to determine whether the second condition is met, and
determine whether the secondary topic finding process is triggered based on whether each of the second conditions is met; and
determine at least one secondary topic that is identified by the at least one secondary topic model and is non-overlapping with any primary topic identified by the primary topic model, when it is determined the secondary topic finding process is triggered.

11. The system of claim 10, wherein the at least one secondary topic is determined based on:
generating, for each respective topic identified based on each respective topic model of the plurality of topic models, a third cluster including sentence-level embeddings representing every sample sentence generated for the respective topic associated with the at least one document;
comparing primary topics identified based on the primary topic model to secondary topics identified based on the at least one secondary topic model by applying the plurality of cluster comparison models to the third clusters to generate a topic score for each secondary topic; and
determining the at least one secondary topic based on one or more secondary topics whose topic scores are higher than a threshold.

12. The system of claim 11, wherein the at least one processor is configured to read the instructions to:
remove, from the topic related data, each secondary topic whose topic score is lower than the threshold; and
add, to the topic related data, the at least one secondary topic whose topic score is higher than the threshold, wherein the topic related data includes:
the primary topics,
the at least one secondary topic, and
sample sentences generated for each of the primary topics and the at least one secondary topic.

13. The system of claim 12, wherein the at least one processor is configured to read the instructions to:
obtain an inference document;
retrieve the topic related data from the database;
generate first sentence embeddings for sentences in the inference document;
generate second sentence embeddings for sample sentences in the topic related data; and
apply a few-shot classifier to the first sentence embeddings and the second sentence embeddings to identify at least one predicted topic for the inference document.

14. A computer-implemented method, comprising:
obtaining at least one document;
applying a plurality of topic models to the at least one document to identify at least one topic associated with the at least one document;
selecting a topic model from the plurality of topic models based on the at least one topic;
generating topic related data comprising data associated with a topic identified based on the selected topic model; and
storing the topic related data in a database.

15. The computer-implemented method of claim 14, selecting the topic model comprises:
computing, for each respective topic model of the plurality of topic models, an overlapping score indicating a level of overlap between topics identified based on the respective topic model and topics identified based on the remaining topic models of the plurality of topic models;
ranking the plurality of topic models based on their respective overlapping scores; and
selecting the topic model as a primary topic model that has the highest overlapping score among the plurality of topic models, wherein the plurality of topic models comprises the primary topic model and at least one secondary topic model.

16. The computer-implemented method of claim 15, further comprising:
generating a first ranking of the plurality of topic models based on their respective second scores;
generating a second ranking of the plurality of topic models based on their respective third scores;
determining a topic confidence score based on a comparison of the first ranking and the second ranking;
generating, for each respective topic model of the plurality of topic models, a first cluster including embedding points each representing a topic description generated for a respective topic identified based on the respective topic model;
generating, for each respective topic model of the plurality of topic models, a second cluster including embedding points each being a centroid of embeddings of sample sentences generated for a respective topic identified based on the respective topic model;
applying a plurality of cluster comparison models to the first clusters corresponding to the plurality of topic models to generate a first plurality of cluster supported scores; and
applying the plurality of cluster comparison models to the second clusters corresponding to the plurality of topic models to generate a second plurality of cluster supported scores.

17. The computer-implemented method of claim 16, further comprising:
determining whether the topic confidence score is larger than a predetermined threshold;
when the topic confidence score is larger than the predetermined threshold,
comparing each of the first plurality of cluster supported scores to a respective first threshold to determine whether a first condition is met,
comparing each of the second plurality of cluster supported scores to a respective second threshold to determine whether a second condition is met, and
determining whether a secondary topic finding process is triggered based on whether each of the first conditions and the second conditions is met;
when the topic confidence score is not larger than the predetermined threshold,
comparing each of the second plurality of cluster supported scores to the respective second threshold to determine whether the second condition is met, and
determining whether the secondary topic finding process is triggered based on whether each of the second conditions is met; and
determining at least one secondary topic that is identified by the at least one secondary topic model and is non-overlapping with any primary topic identified by the primary topic model, when it is determined the secondary topic finding process is triggered.

18. The computer-implemented method of claim 17, determining the at least one secondary topic comprises:
generating, for each respective topic identified based on each respective topic model of the plurality of topic models, a third cluster including sentence-level embeddings representing every sample sentence generated for the respective topic associated with the at least one document;
comparing primary topics identified based on the primary topic model to secondary topics identified based on the at least one secondary topic model by applying the plurality of cluster comparison models to the third clusters to generate a topic score for each secondary topic; and
determining the at least one secondary topic based on one or more secondary topics whose topic scores are higher than a threshold,
wherein each secondary topic, whose topic score is lower than the threshold, is removed from the topic related data, and the topic related data includes:
the primary topics,
the at least one secondary topic, and
sample sentences generated for each of the primary topics and the at least one secondary topic.

19. The computer-implemented method of claim 18, further comprising:
obtaining an inference document;
retrieving the topic related data from the database;
generating first sentence embeddings for sentences in the inference document;
generating second sentence embeddings for sample sentences in the topic related data; and
applying a few-shot classifier to the first sentence embeddings and the second sentence embeddings to identify at least one predicted topic for the inference document.

20. A non-transitory computer readable medium having instructions stored thereon, wherein the instructions, when executed by at least one processor, cause at least one device to perform operations comprising:
obtaining at least one document;
applying a plurality of topic models to the at least one document to identify at least one topic associated with the at least one document;
selecting a topic model from the plurality of topic models based on the at least one topic;
generating topic related data comprising data associated with a topic identified based on the selected topic model; and
storing the topic related data in a database.
